(19) United States
(12) Patent Application Publication
(10) Pub. No.: US 2021/0147118 A1
(43) Pub. Date: May 20, 2021

(54) SYSTEMS AND METHODS FOR TRACKING CHAIN OF CUSTODY OF A CONTAINER AND ITS CONTENTS

(71) Applicant: ARK Operations, Inc., Centerville, OH (US)

(72) Inventor: Kenneth Schroeder, Centerville, OH (US)

(21) Appl. No.: 17/100,458

(22) Filed: Nov. 20, 2020

Related U.S. Application Data
(60) Provisional application No. 62/937,856, filed on Nov. 20, 2019.

(51) Int. Cl. B65D 23/14; B65D 25/20; B65D 43/02; B65D 53/02; G06Q 30/00; G06K 7/10; G06K 19/07

(52) U.S. Cl. CPC B65D 23/14; B65D 25/205; B65D 43/0283; B65D 53/02; G06K 2007/10504; G06K 7/10297; G06K 19/0723; B65D 2401/05; G06Q 30/0185

(57) ABSTRACT

A chain of custody tracking system. The chain of custody tracking system can include a container, the container having a bottom at a lower portion and at least one sidewall extending from the bottom to a peripheral edge at an upper portion, the peripheral edge defining an opening. The upper portion of the container sidewall can have a channel having a channel height, the channel height being defined by a first extension of the sidewall and a second extension of the sidewall. The first extension of the sidewall can be a rib, the rib having a sloped surface that extends outwardly from the sidewall. the chain of custody tracking system has a first condition wherein a first lid is removably coupled to the container and removably coupled to a first indicator, and a second condition wherein the first lid is uncoupled from the first indicator.

### CROSS REFERENCE TO RELATED APPLICATION

This application claims the benefit of U.S. Provisional Patent Application Ser. No. 62/937,856, filed on Nov. 20, 2019, entitled “SYSTEMS AND METHODS FOR TRACKING CHAIN OF CUSTODY OF A CONTAINER AND ITS CONTENTS,” the disclosure of which is hereby incorporated herein by reference in its entirety.

### TECHNICAL FIELD

Embodiments of the technology relate, in general, to tracking chain of custody technology, and in particular to systems and methods for tracking the chain of custody of a container and its contents.

### BACKGROUND

Evidence handling systems and standard law enforcement procedures are in place for collecting, logging, maintaining, and handling evidence. These systems are typically paper trail based. Evidence is often transported from, for example, a law enforcement agency to labs or police evidence storage where the access is tracked by logs. A wide range of persons have access to the evidentiary items during the process of investigation and preparation for trial including, for example, law enforcement personnel, technicians, attorneys, defendants, and expert witnesses. Improper tracking of the chain of custody of evidence may negatively affect an investigation or trial. Further, there may be safety or health issues for those handling certain evidence. Fentanyl, for example, is a dangerous substance often found at crime scenes or on traffic stops. Existing handling processes may require an elaborate system of multiple bags or containers to secure such dangerous evidence. The longer a piece of dangerous or harmful evidence must be handled, the greater the risk of accidental exposure.

There is a substantial and significant unmet need to provide a safe, secure and trackable chain of custody system that is easy to use and reasonable in cost.

### BRIEF DESCRIPTION OF THE DRAWINGS

The present disclosure will be more readily understood from a detailed description of some example embodiments taken in conjunction with the following figures:

FIG. 1 is an exploded view of a tracking system according to an embodiment.

FIG. 2 is a cross-sectional view of a tracking system according to an embodiment.

FIG. 3 is an enlarged view of the encircled portion of the tracking system of FIG. 2.

FIG. 4 is a perspective view of a tracking system according to an embodiment showing a container and a lid.

FIG. 5 is a perspective view of the tracking system of FIG. 4 showing the container coupled to the lid of FIG. 4.

FIG. 6 is a perspective view of the tracking system of FIG. 4 showing the first lid being separated from a first indicator.

FIG. 7 is a perspective view of the tracking system of FIG. 4 showing the container and a first indicator.

FIG. 8 is a perspective view of the tracking system of FIG. 4 including a second lid.

FIG. 9 is a perspective view of the tracking system of FIG. 4 showing the container coupled to the second lid of FIG. 8.

FIG. 10 is a perspective view of the tracking system of FIG. 4 showing the container, the first indicator, and the second indicator after the second lid has been removed.

FIG. 11 is a perspective view of the tracking system of FIG. 4 showing the container, the first indicator, the second indicator, and a third lid coupled to the container.

FIG. 12 shows a step in a method of using a tracking system according to various embodiments.

FIG. 13 shows a step in a method of using a tracking system according to various embodiments.

FIG. 14 shows a step in a method of using a tracking system according to various embodiments.

FIG. 15 shows a step in a method of using a tracking system according to various embodiments.

FIG. 16 shows a step in a method of using a tracking system according to various embodiments.

FIG. 17 shows a step in a method of using a tracking system according to various embodiments.

FIG. 18 shows a step in a method of using a tracking system according to various embodiments.

FIG. 19 shows a step in a method of using a tracking system according to various embodiments.

FIG. 20 shows a step in a method of using a tracking system according to various embodiments.

FIG. 21 shows a step in a method of using a tracking system according to various embodiments.

FIG. 22 is an elevation view of a tracking system according to an embodiment.

FIG. 23 is a cross-sectional view of the tracking system taken along line B-B of FIG. 22.

FIG. 24 is an enlarged view of the encircled portion of the tracking system of FIG. 23.

FIG. 25 is a perspective view of a tracking system according to an embodiment including a container and a lid.

FIG. 26 is a perspective view of the tracking system of FIG. 25 showing the container coupled to the lid.

FIG. 27 is a side perspective view of the tracking system of FIG. 25 showing the lid with the seal removed.

FIG. 28 is a perspective view of the tracking system of FIG. 25 showing the lid removed from the container.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for tracking the chain of custody of a container and its contents (e.g., evidence). In one example embodiment, a container is configured to provide a trackable chain of custody of the evidence therein. In some embodiments, the container is repeatedly sealable. For example, in some embodiments, when a lid is removed from the container, an indicator remains with the container. The indicator represents a link in the chain of custody. Because the process can be repeated, a series of indicators may remain on the container and display the chain of custody as described further below. Additionally, the system reduces the time it takes a user to secure the evidence compared to existing procedures with more than one bag or container. This reduces the time that a handler may be exposed to potentially dangerous or harmful evidence.

The examples discussed herein are examples only and are provided to assist in the explanation of the apparatuses, devices, systems and methods described herein. While the examples discussed herein are described in connection with tracking the chain of custody of a container holding evidence, the technology is not so limited. The technology may be used in other applications where tracking chain of custody is useful. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

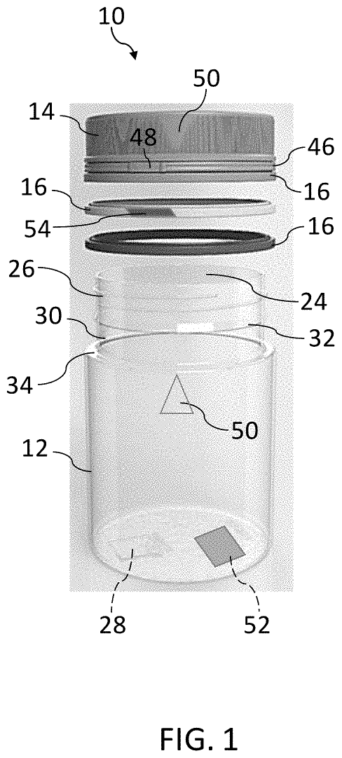

With reference to FIGS. 1-28, according to an example embodiment, the tracking system 10 includes a container 12 and at least one lid 14 that is selectively coupled to the container 12. The lid 14 may be a tamper-proof lid. The tracking system 10 further includes at least one indicator 16 that, in various configurations, is separably coupled to the lid 14 or movably coupled to the container 12. The container 12, lid 14, and indicators 16 are discussed further below.

Referring to FIGS. 1-3, in various embodiments, the container 12 includes a container body 18 having a bottom surface 20, a sidewall 22, and an opening 24. The container body 18 may include an attachment member 26 configured to selectively couple the lid 14 to the container 12. In an embodiment, the attachment member 26 includes threads that allow the lid 14 to be screwed onto the container 12. In another embodiment, the attachment member 26 can be configured to permit the lid 14 to snap onto the container 12. The container 12 may include a trackable seal or number 28. In an embodiment, the trackable seal or number 28 may be engraved and/or molded into or on the container 12, and/or printed on, and/or included on a sticker attached to the container body 18 of the container 12. In another embodiment, the container 12 may include an RF ID chip 52 that may also facilitate transmittable data. The trackable seal or number 28 may represent each piece of evidence placed in the container 12 and remains with this piece of evidence through the entire evidence chain of custody. Providing this seal or number 28 allows a handler to book evidence on scene by entering an individual container number or scanning a code into an evidence tracking software.

In some embodiments, the container 12 includes a channel 30 having a first end and a second end. In the embodiment of the tracking system 10 illustrated, the channel 30 is a concentric indentation of the sidewall 22 between the bottom surface 20 and the opening 24. The first and second ends of the channel 30 are defined by a first stop 32 and a second stop 34, respectively. The portion of the container 12 including the opening 24, attachment member 26, channel 30, the first stop 32 and the second stop 34 may be referred to as the upper portion of the container 12, while the remainder may be referred to as the lower portion of the container 12 (or vice versa).

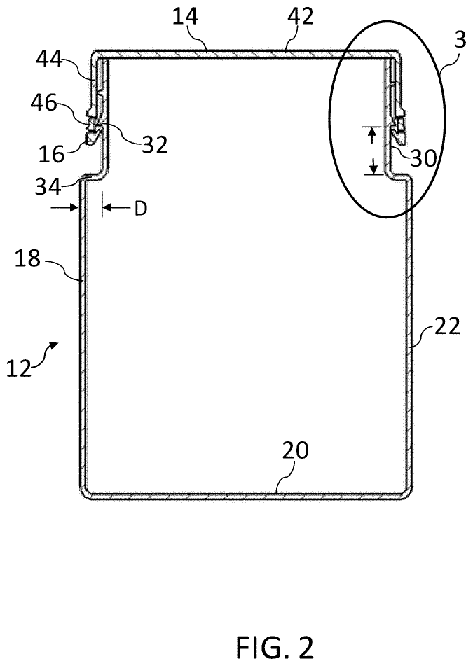

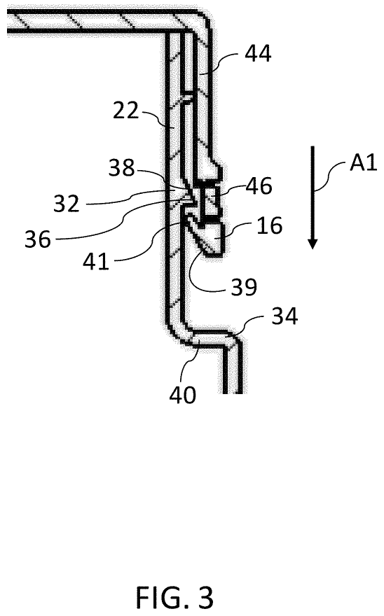

The first stop 32, in various embodiments, is configured to allow an indicator 16 coupled to the lid 14 to move distally, that is, in the direction of arrow A1 in FIG. 2, past the first stop 32 and into the channel 30 when the lid 14 is being coupled to the container 12. When the lid 14 is being removed, the first stop 32 is configured to prevent the indicator 16 from moving proximally, that is, in the opposite direction of arrow A1, past the first stop 32. For example, as shown in FIG. 3, the container 12 includes a rib 36 extending outwardly from the sidewall 22. The rib 36 may have a varying rib height, which is the dimension measured orthogonally from the sidewall. The rib 36 includes, in an example, a sloped surface 38 where the rib height increases along the sloped wall 38 in a direction away from the opening of the container 12. In other words, the rib 36 is larger at an end closer to the bottom surface 20 of the container 12 compared to the end closer to the opening 24. Likewise, the indicator 16 can have an inwardly oriented indicator sloping portion 39, such that as the lid 14 is coupled to the container 12 the surface of the sloped wall 38 and the sloping portion 39 engage in a slidingly moveable manner, urging the indicator 16 slightly outwardly from the container until a distal tip portion 41 of the indicator 16 is urged past the tip of the rib 36, and can “snap” back into place, as is the configuration shown in FIG. 3. Thus, as can be understood, the varying height of the sloped wall 38 allows the indicator 16 to slide distally over the rib 36 and snap into the channel 30 but prevents the indicator 16 from moving proximally over the rib 36 out of the channel 30. Because the first stop 32 prevents the indicator 16 from moving proximally over the first stop 32 once it is in the channel 30, the first stop 32 prevents the lid 14 from being removed from the container 12 while the lid 14 and indicator 16 are coupled, for example, via a removable seal 46, as disclosed more fully below.

In various embodiments, the second stop 34 is configured to prevent the indicator 16 from moving distally along the container 12 (e.g., towards the bottom surface 20 of the container 12, in the direction of arrow A1). In the example embodiment shown in FIG. 3, the second stop 34 is a shelf 40. When the lid 14 is placed on the container 12, the indicator 16 passes over the first stop 32 and enters the channel 30. When the lid 14 is removed, the indicator 16 remains in the channel 30 as discussed further below. While the indicator 16 may be movable within the channel 30, the second stop 34 prevents the indicator 16 from falling off the container 12. As shown in FIG. 3, the indicator 16 is contained in the channel 30 between the rib 36 and the shelf 40. The channel 30 is configured to retain at least one indicator 16. The height H and depth D of the channel 30 may vary. The height H of the channel 30 is configured to be larger than the height of at least one indicator 16. For example, in various embodiments, the height H of the channel 30 may be larger than the combined heights of more than one, two, three, four, five, six, seven, eight, nine, ten, or more than ten indicators 16.

In various embodiments, the shape, materials, and size of the container 12 may vary. Further, the shape, materials, and relative size of the upper and lower portions of the container 12 may vary relative to each other. In the embodiment shown in FIG. 1, the container 12 is an open cylinder with a circular sidewall extending from the bottom surface. However, the tracking system 10 is not so limited. Additionally, the container body 18 may be rigid, flexible, or may have both rigid and flexible portions. In an embodiment where the container body 18 includes both rigid and flexible portions, the portion of the container 12 including the attachment member 26, channel 30, and first and second stops 32, 34 (e.g., the upper portion) may be rigid. The container 12 may be made of, without limitation, a plastic such as high-density polypropylene. The size of the container 12 may vary. For example, the lower portion of the container 12 may be 3 inches in height and 3 inches in diameter.

Continuing to refer to FIGS. 1-3, in various embodiments, the lid 14 includes a lid body 42 and a lid skirt 44 extending therefrom. The lid skirt 44 may include a lid attachment feature that corresponds to or mates with the body attachment member 26 of the container 12, such as corresponding threads. In an embodiment, the lid skirt 44 includes a thread that mates with the thread of the attachment member 26 of the container 12. As discussed further below, the lid 14 may be separably coupled to the indicator 16.

Still referring to FIGS. 1-3, in an embodiment, each indicator 16 may transition from a first configuration to a second configuration. In the first configuration, the indicator 16 is separably coupled to a lid 14. Before the lid 14 has been coupled to the container 12 or, if coupled, before the lid 14 has been removed from the container 12, the indicator 16 may be in the first configuration. When the lid 14 is coupled to the container 12, the indicator may be positioned in the channel 30 of the container body 18. In the second configuration, the indicator 16 is coupled to the container 12 and not the lid 14. When the lid 14 has been removed from the container 12, the indicator 16 is in the second configuration. To transition between the first and second configurations, the indicator 16 is separated from the lid 14. When the lid 14 is coupled to the container 12, the indicator 16 can be separated from the lid 14, at which time the indicator 16 is contained in the channel 30. The indicator 16 may be, for example, an annular ring. The connection between the lid 14 and indicator 16 may act as an anti-tamper feature. If a lid 14 is secured to the container 12 but is separated from any indicator 16, it may mean the container 12 has been accessed by an unauthorized user. Multiple lids 14 may be used to successively secure the same container 12 after the evidence has been accessed. As described above, the channel 30 may be configured to retain more than one indicator 16. Additionally, the indicators 16 may be sized to rest against each other when contained in the channel 30. For example, when two indicators 16 are in the channel, the indicators 16 can be positioned next to each other; one of the indicators 16 would not, for example, fall between the other indicator 16 and the container 12 so that only one indicator 16 is visible.

In an embodiment, the indicator 16 is separably coupled to the lid 14 via a removable seal 46. The removable seal 46 is separably coupled to each of the lid 14 and the indicator 16. The removable seal 46 can be, for example, a frangible member that can be relatively easily torn away from the lid 14. The removable seal 46 may include a lip 48 that extends outwardly from the container 12 to allow easier removal of the removable seal 46 from the lid 14. The removable seal 46 can be, in an embodiment, a tearable strip that, when grasped by the lip 48 can be torn away from the lid 14, thereby removing the connection between the lid 14 and the indicator 16. In an embodiment, the removable seal is not a continuous strip, but can be one or more discrete, removable connections between the lid and an indicator. When the removable seal 46 is removed, the respective indicator 16 and lid 14 are no longer coupled. Without the indicator 16 being coupled to the lid 14, the lid 14 may be removed from the container 12. The indicator 16, however, remains coupled to the container 12.

Each of the indicators 16 may be configured to represent a certain link in a chain of custody. For example, the indicators 16 may visually indicate certain information, such as who has handled the evidence in the container 12. In an embodiment, each indicator 16 may have a different indicia, such as a different color. The color may represent a certain department or type of evidence handler such as, for example, a first responder, a lab technician, and a storage area. As the evidence is repeatedly accessed and secured, the number of indicators 16 coupled to the container 12 increases. Because each indicator 16 can correspond to a certain user or department, one is able to determine who has opened and secured the container 12 based on the sequence of the indicators 16. Each indicator 16 may be electronically identifiable. For example, an indicator 16 may include an indicator RFID chip or tag 54. In an embodiment, any of the indicator, lid 14, or container 12 may include a department logo or a state agency seal incorporated as, for example, etchings, stamps or engravings.

In an embodiment, each of the container 12 and the lid 14 may include an alignment feature. For example, with reference to FIG. 1, the container 12 and the lid 14 both include an arrow 50. When coupling the lid 14 to the container 12, the handler may align the arrows 50 to ensure the lid 14 is properly secured. The arrow 50 on either of the container 12 or lid 14 may be printed on, molded into, or otherwise visibly disposed thereon. Other alignment features can be used, such as linear indicators, including lines that can be aligned upon proper securement.

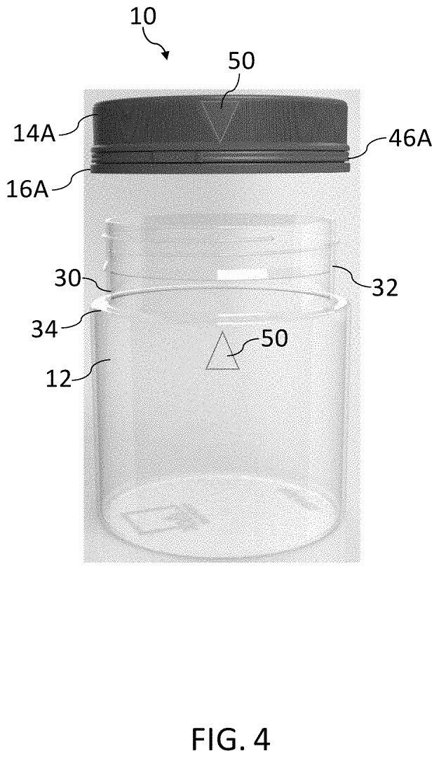

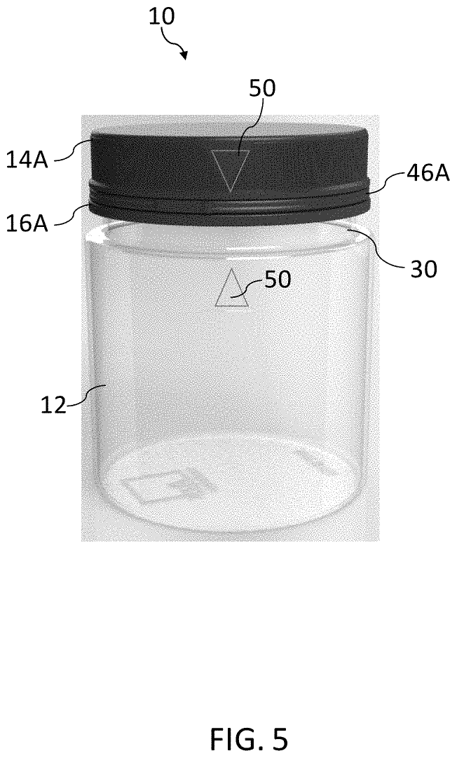

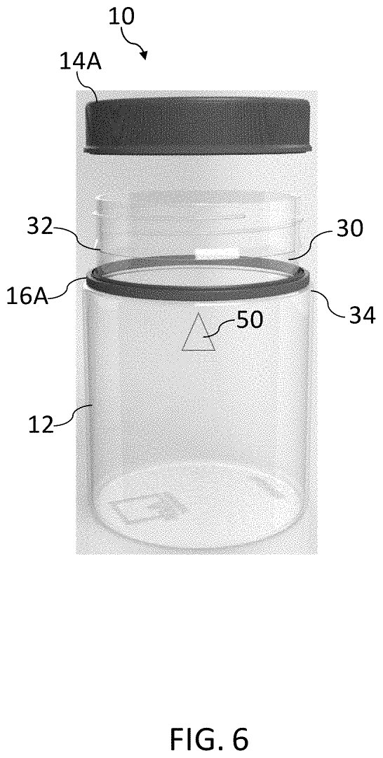

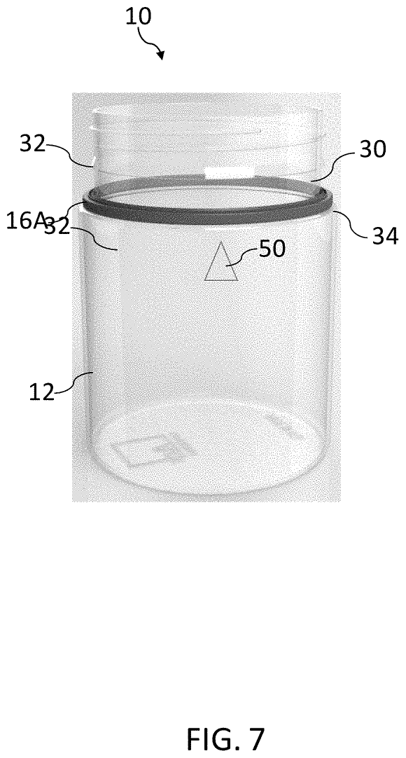

Referring to FIGS. 4-12, according to an example embodiment, a method includes providing a container 12 and a first lid 14A having a first indicator 16A. As shown in FIG. 5, the first lid 14A can be coupled to the container 12 such that the first indicator 16A is urged past the first stop 32 and into the channel 30 of the container 12. Thus, the tracking system 10 is shown in FIG. 5 as being in a first closed configuration with the first indicator 16A disposed in the channel 30 and coupled to the first lid 14A. Referring to FIG. 6, the first lid 14A is then separated from the first indicator 16A and the first lid 14A can be un-coupled from the container 12. To separate the first lid 14A from the first indicator 16A, a first removable seal 46A may be removed. The first indicator 16A is then free to move through the channel 30 to a second stop 34, which prevents the first indicator 16A from falling off the container 12. The first lid 14A may then be removed from the container 12 while the first indicator 16A remains in the channel 30, as depicted in FIG. 7.

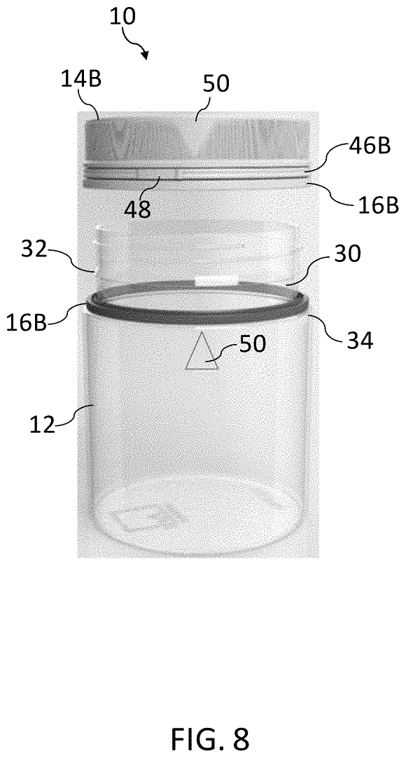

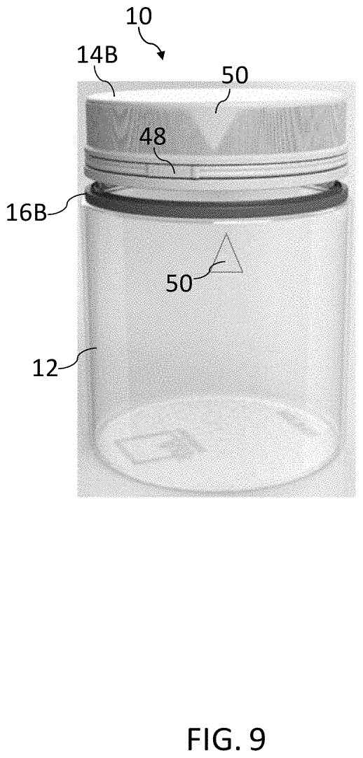

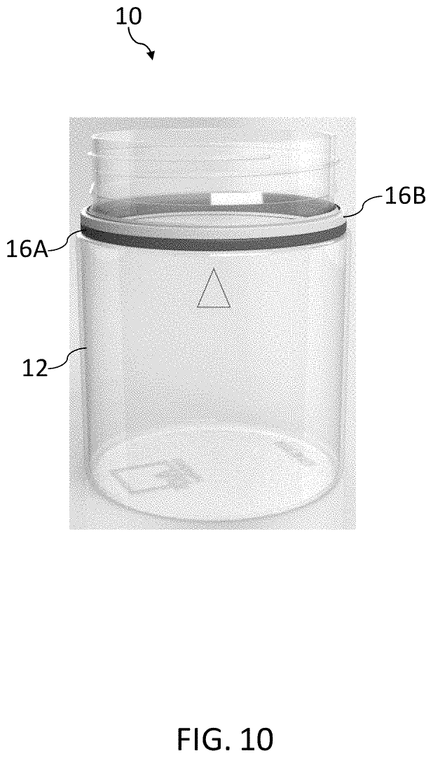

In accordance with an embodiment, and as shown in FIG. 8, a second lid 14B with a second indicator 16B may be provided and coupled to the container 12, as shown in FIG. 9. The process to remove the second lid 14B is the same as for removing the first lid 14A. As shown in FIG. 10, when the second indicator 16B is separated from the second lid 14B and the second lid 14B is removed, the channel 30 contains the first indicator 16A and the second indicator 16B. In an embodiment, the first indicator 16A and the second indicator 16B are sized such that their sequenced relationship is maintained, that is, the second indicator 16B cannot be moved below the first indicator 16A, or vice versa.

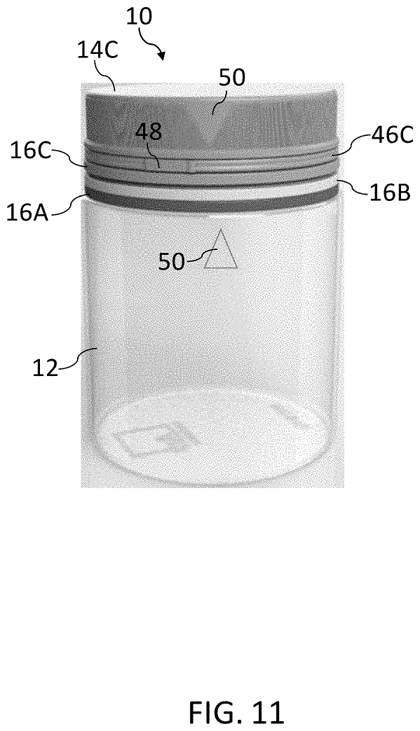

Referring now to FIG. 11, a third lid 14C, including a third indicator 16C coupled thereto by a third removable seal 46C, may be coupled to the container 12, and the process may be repeated. Because each of the indicators 16A, 16B, and 16C can have a separate meaning or indicia, represented by, for example, distinct colors, the container 12 tracks the chain of custody of who has had access to and secured the evidence contained therein.

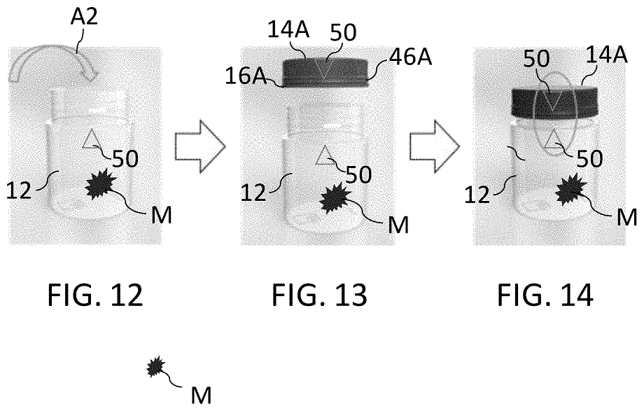

With reference to FIGS. 12-21, in an example use of the tracking system 10, a first person, such as a first responder (e.g., from a law enforcement agency) secures matter M to be tracked, such as a piece of evidence, in a container 12, by putting it into the container 12, as indicated by the arrow A2 of FIG. 12A. A first lid 14A with a first indicator 16A and a first removable seal 46A can be provided, as shown in FIG. 13. In the illustrated embodiment, the first lid 14A uses a lid with a black first indicator 16A. The first person, e.g., the first responder, may couple the first lid 14A onto the container 12, as shown in FIG. 14, and can align the arrows 50 on the container and the lid, as indicated in the circled region of FIG. 14.

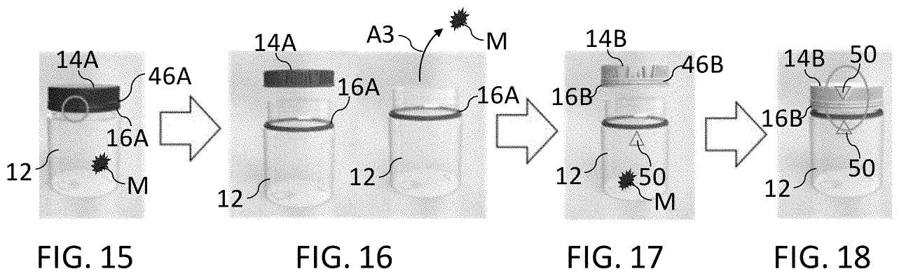

Continuing to illustrate a use example, the container 12 with the first lid 14A coupled to the container 12 is transferred to a lab where a second person, such as a lab technician, removes the first removable seal 46A, by, for example, grasping and pulling on the lip 48, as described above, and separates the first lid 14A and the (black) first indicator 16A, which remains on the container 12, as indicated in FIGS. 15-18. The technician accesses the matter M by removing the first lid 14A and, optionally, removing the matter M, as shown in FIG. 16. The technician can perform a task and return the matter into the container 12, as shown in FIG. 17. The technician secures the container with a second lid 14B having a second indicator 16B secured with a second removable seal 46B, as shown in FIG. 18, and couples, such as by screwing on, the second lid 14B until the the second indicator 16B is disposed in the channel 30, and optionally, alignment arrows 50, as shown in the circled portion of FIG. 18. In the illustrated embodiment, the second lid 14B and/or the second indicator 16B can be white.

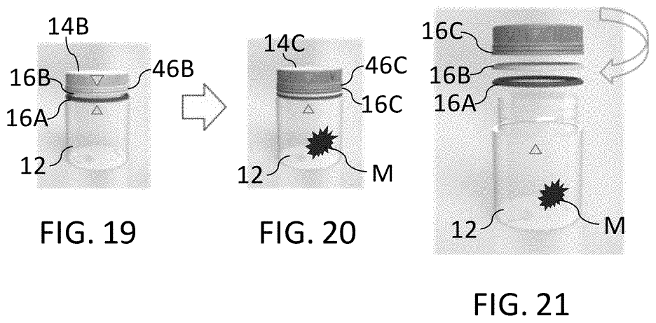

Continuing the illustrated use embodiment, the container is transported to a police department where the container is placed in storage. If a third person, such as a court agency needs to examine or use the matter M, the second removable seal 46B is removed to separate the second lid 14B and (white) second indicator 16B, all of which are shown on the container 12 in a closed and arrow-aligned configuration in FIG. 19. Repeating the above steps, after opening the second lid 14B, the court agency may then seal the matter M again in the container 12 with a third lid 14C with a third indicator 16C, as shown in FIG. 20. In an embodiment, the third lid 14C and/or the third indicator 16C can be red. When the container 12 is next retrieved, the indicators remaining on the container 12 inform the handler that the matter M, e.g., evidence, was first secured by a first person, e.g., a responder at a law enforcement agency, based on the (black) first indicator 16A, then accessed by a second person, e.g., a lab technician, based on the (white) second indicator 16B between the first indicator 16A and the (red) third indicator 16C, and finally accessed by a court agency based on the third indicator 16C coupled to the lid, as indicated in FIGS. 20 and 21.

In an example use of the tracking system 10, the matter, e.g., evidence, in the container 12 may be tracked electronically. For example, the container 12 or the lid 14 may include tracking data (e.g., the tracking number 38), and the tracking data may be transmittably communicated via the above-described RFID tags. In use, the person handling the container, such as the first responder, may record and/or enter the tracking data and other relevant information into a software program. The person, e.g., the technician, may also enter the tracking data to retrieve the evidence record.

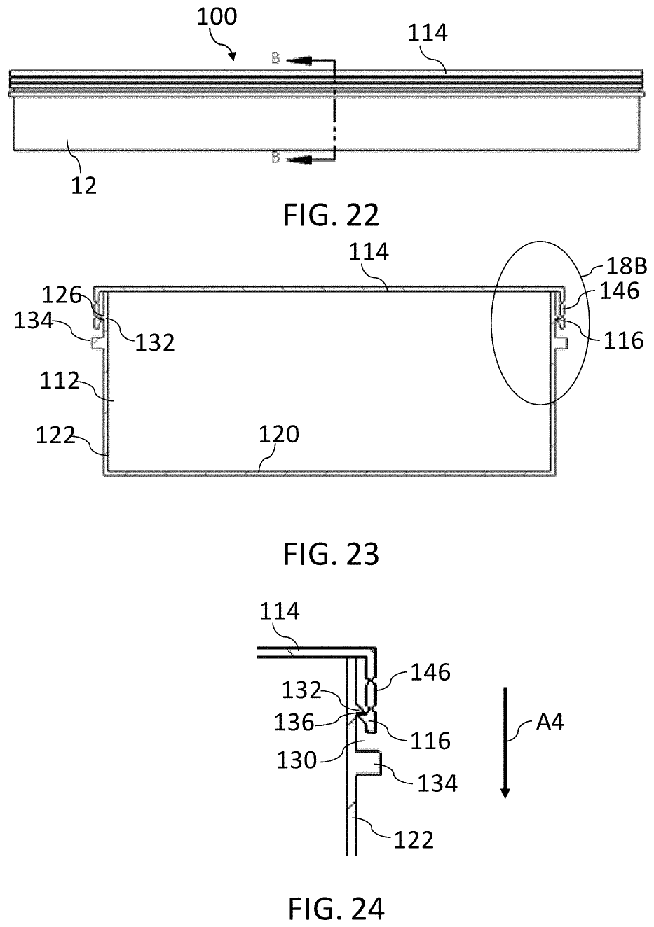

As discussed above, in various embodiments, the shape, materials, and size of the container 12 may vary. With reference to FIGS. 22-28, in another embodiment, there is described a tracking system 100 that illustrates that the tracking system may have other shapes, specifically by example, a rectangular shape, e.g., a box-like configuration. However, the box-like tracking system 100 can have the same working structure, function, and benefits as described above, and the description herein of the box-like embodiment utilizes similar terms for similar structures. In such an embodiment, the lid 114 may be a snap-on lid. An indicator 116 can be coupled to the lid 114 by a removable seal 146 and, as described above, when the removable seal 146 is removed from the lid 114, the lid 114 may be lifted off the container 112 while the indicator 116 remains on the container, constrained in a channel 130 between a first stop 132 and a second stop 134. In an embodiment, the second stop 134 may be a projection from the sidewall 122. The rectangular-shaped tracking system 100 may be used according to the example methods described above.

According to an example embodiment, the tracking system 100 includes a container 112 and at least one lid 114 that is selectively coupled to the container 112. The lid 114 may be a tamper-proof lid. The tracking system 110 further includes at least one indicator 116 that, in various configurations, is separably coupled to the lid 114 or movably coupled to the container 112. The container 112, lid 114, and indicator(s) 116 operate in use as do the container 12, lid(s) 14 and indicator(s) discussed above. Further, the tracking system 100 can utilize any or all of the other structure disclosed above with respect to the tracking system 10, with it understood that shapes may be modified from generally circular and/or cylindrical, to generally rectangular and/or box-like. In some embodiments, the container 112 includes a channel 130 having a first end and a second end. The first and second ends of the channel 130 are defined by a first stop 132 and a second stop 134, respectively. The portion of the container 112 including the opening 124, attachment feature 126, channel 130, the first stop 132 and the second stop 134 may be referred to as the upper portion of the container 112, while the remainder may be referred to as the lower portion of the container 112 (or vice versa).

The first stop 132, in various embodiments, is configured to allow an indicator 116 coupled to the lid 114 to move distally, that is, in the direction indicated by arrow A4, past the first stop 132 and into the channel 130 when the lid 114 is being coupled to the container 112. When the lid 114 is being removed, the first stop 132 is configured to prevent the indicator 116 from moving proximally past the first stop 132. For example, as shown in FIG. 16, the container 112 includes a rib 136 extending outwardly from the sidewall 122. The rib 36 may have a varying height from the sidewall. The rib 136 includes, in an example, a sloped wall 138 where the height increases along the sloped wall 138 in a direction away from the opening of the container 112. In other words, the rib 136 is larger at an end closer to the bottom surface 120 of the container 112 compared to the end closer to the opening 124. This varying height allows the indicator 116 to slide distally over the rib 136 and snap into the channel 130 but prevents the indicator 116 from moving proximally over the rib 136 out of the channel 130. Because the first stop 132 prevents the indicator 116 from moving proximally over the first stop 132 once it is in the channel 130, the first stop 132 prevents the lid 114 from being removed from the container 112 while the lid 114 and indicator 116 are coupled.

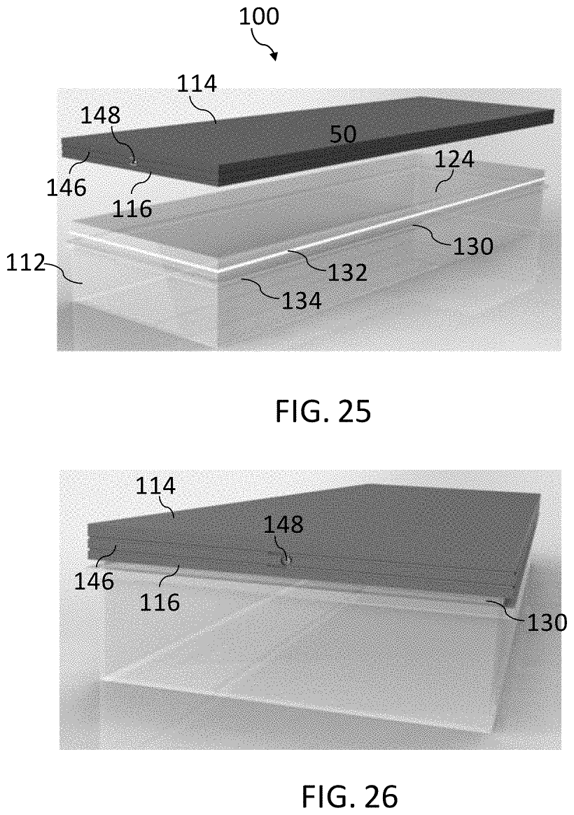

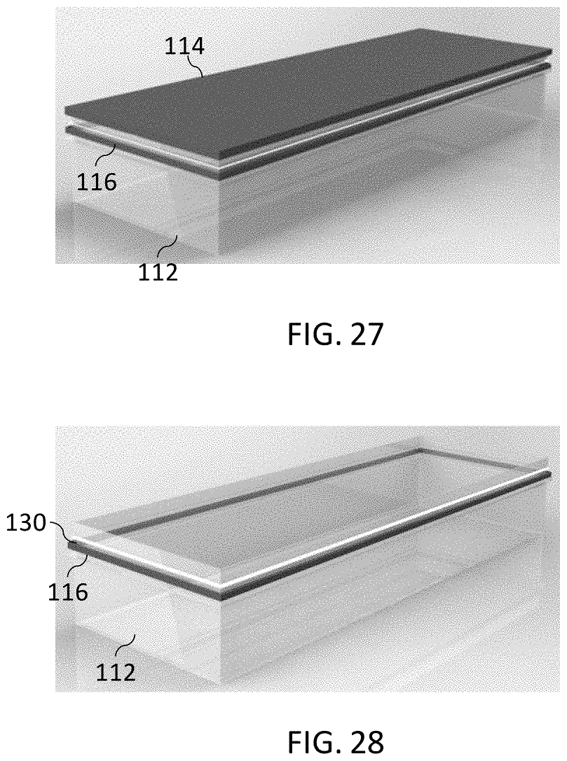

FIG. 25 shows a tracking system 100 with the lid 114 not attached to the container 112. FIG. 26 shows a tracking system 100 with the lid 114 attached to the container 112. In FIGS. 25 and 26 the indicator 116 is coupled to the lid via a removable seal 146 which can be a strip-like member having a lip 148 for grasping for removal. FIG. 27 shows the removable seal 146 is removed, and once the lid 114 is removed, as shown in FIG. 28, the indicator 116 remains in the channel 130 of the container 112.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A chain of custody tracking system, comprising
a. a container, the container having a bottom at a lower portion and at least one sidewall extending from the bottom to a peripheral edge at an upper portion, the peripheral edge defining an opening,
b. wherein on the upper portion of the container the sidewall has a channel having a channel height, the channel height being defined by a first extension of the sidewall and a second extension of the sidewall, the first extension of the sidewall being a rib, the rib having a sloped surface that extends outwardly from the sidewall,
c. the system having a first condition wherein a first lid is removably coupled to the container and removably coupled to a first indicator, and
d. the system having a second condition wherein the first lid is uncoupled from the first indicator.

2. The chain of custody tracking system of claim 1, wherein the container is generally cylindrical having a generally circular-shaped peripheral edge.

3. The chain of custody tracking system of claim 1, wherein the container is generally box-shaped having a generally rectangular-shaped peripheral edge.

4. The chain of custody tracking system of claim 1, wherein in the first condition the first indicator is disposed in the channel.

5. The chain of custody tracking system of claim 1, wherein in the second condition the first lid is uncoupled from the container and the first indicator is disposed in the channel.

6. The chain of custody tracking system of claim 1, wherein the first lid is removably coupled to the first indicator by a removable seal.

7. The chain of custody tracking system of claim 1, wherein the first lid is removably coupled to the first indicator by a removable seal, the removable seal being a strip of material.

8. A chain of custody tracking system, comprising
a. a container, the container having a bottom at a lower portion and at least one sidewall extending from the bottom to a peripheral edge at an upper portion, the peripheral edge defining an opening,
b. wherein on the upper portion of the container the sidewall has a channel having a channel height, the channel height being defined by a first extension of the sidewall and a second extension of the sidewall, the first extension of the sidewall being a rib, the rib having a sloped surface that extends outwardly from the sidewall,
c. a first lid, the first lid being removably coupled to a first indicator, the first indicator being a size and shape to reside in the channel when the first lid is coupled to the container, and
d. a second lid, the second lid being removably coupled to a second indicator, the second indicator being a size and shape to reside in the channel when the first lid is removed and the second lid is coupled to the container.

9. The chain of custody tracking system of claim 8, wherein the container is generally cylindrical having a generally circular-shaped peripheral edge.

10. The chain of custody tracking system of claim 8, wherein the first indicator is visually distinct from the second indicator.

11. The chain of custody tracking system of claim 8, wherein the first indicator is a first color and the second indicator is a second color, different from the first color.

12. The chain of custody tracking system of claim 8, wherein the first lid is removably coupled to the first indicator by a removable seal.

13. The chain of custody tracking system of claim 8, wherein the first lid is removably coupled to the first indicator by a first removable seal, the first removable seal being a frangible strip of material.

14. A container, the container comprising:
a. a container body, the container body comprising having a bottom at a lower portion and at least one sidewall extending from the bottom to a peripheral edge at an upper portion, the peripheral edge defining an opening, the container body having a container attachment member on the sidewall near the peripheral edge, and a first extension of the sidewall, the first extension of the sidewall being a rib, the rib having a sloped rib surface that extends outwardly from the sidewall, the rib defining a first portion of a channel defined in the sidewall,
b. a lid removably coupled to the container body, the lid having a lid body and a lid skirt extending from the lid body, the lid skirt having a lid attachment member that matingly engages the container attachment member, the lid being removably coupled to an indicator, the indicator having an inwardly oriented indicator sloping portion and a distal tip portion, the distal tip portion being disposed in the channel.

15. The container of claim 14, wherein the container is made of high-density polypropylene.

16. The container of claim 14, wherein the lid is removably coupled to an indicator by a removable seal.

17. The container of claim 14, wherein the first lid is removably coupled to the first indicator by a first removable seal, the first removable seal being a frangible strip of material.

18. The container of claim 14, wherein the container is generally cylindrical having a generally circular-shaped peripheral edge.

19. The container of claim 14, wherein the container is generally box-shaped having a generally rectangular-shaped peripheral edge.

20. The container of claim 14, wherein the contain comprises a trackable seal.
